(19) United States
(12) Patent Application Publication
(10) Pub. No.: US 2006/0123801 A1
(43) Pub. Date: Jun. 15, 2006

(54) Device for applying cryogenic composition and method of using same

(75) Inventor: David P. Jackson, Saugus, CA (US)

Correspondence Address: DUFAULT LAW FIRM, 10 SOUTH FIFTH STREET, LUMBER EXCHANGE BUILDING, SUITE 920, MINNEAPOLIS, MN, 55402, US

(73) Assignee: Cool Clean Technologies, Inc., Eagan, MN (US)

(21) Appl. No.: 11/301,441

(22) Filed: Dec. 13, 2005

Related U.S. Application Data
(60) Provisional application No. 60/635,399, filed on Dec. 13, 2004.

(51) Int. Cl. F17C 7/02

(52) U.S. Cl. 62/52.1

(57) ABSTRACT

A device of the present invention for applying a cryogenic composition includes a machining tool or tool holder having a channel positioned therethrough and a capillary tube positioned within the channel. A dense cryogenic fluid is passed through the capillary tube while a diluent or propellant fluid is passed through the channel. The diluent or propellant fluid flows within the channel and about the capillary tube. Upon exiting the capillary tube, the dense fluid admixes with the diluent or propellant fluid to form a cryogenic composite fluid or spray. The cryogenic composite fluid or spray is selectively directed onto a substrate for cooling or lubrication purposes, or onto the machining tool for cooling purposes.

### CROSS-REFERENCE TO RELATED APPLICATION(S)

This application claims the benefit U.S. Provisional Patent Application No. 60/635,399 filed on 13 Dec. 2004 entitled METHOD, PROCESS, CHEMISTRY AND APPARATUS FOR SELECTIVE THERMAL CONTROL, LUBRICATION AND POST-CLEANING A SUBSTRATE.

### BACKGROUND OF INVENTION

The present invention generally relates to machining tools. More specifically, the present invention relates to a machining tool that can combine a cutting operation with selective thermal control and/or lubrication during a machining process.

Most machining operations are performed by a cutting tool which includes a holder and one or more cutting inserts each having a top surface terminating with one or more cutting edges. The tool holder is formed with a socket within which the cutting inserts are clamped in place. The leading or cutting edge of an insert makes contact with the workpiece to remove material therefrom in the form of chips. A chip comprises a plurality of thin, generally rectangular-shaped sections of material which slide relative to one another along shear planes as they are separated by the insert from the workpiece. This shearing movement of the thin sections of material relative to one another in forming a chip generates a substantial amount of heat, which, when combined with the heat produced by engagement of the cutting edge of the insert with the workpiece, can amount to 1500 degrees F. to 2000 degrees F.

Among the causes of failure of cutting inserts employed in prior art machining operations are abrasion between the cutting insert and workpiece, and a problem known as cratering. Cratering results from the intense heat developed in the formation of the chips and the frictional engagement of the chips with the cutting insert. As the material forming the chip is sheared from the workpiece, it moves along at least a portion of the exposed top surface of the insert. Due to such frictional engagement, the chip material along the top portion of the insert is removed forming such craters. If the craters are too deep, the entire insert is subject to cracking and failure along its cutting edge, as well as along the sides of the insert upon contact with the workpiece. Cratering has become a particular problem in recent years due to the development and extensive use of hard alloy steels, high strength plastics and composite materials formed of high tensile strength fibers coated with a rigid matrix material such as epoxy.

Prior attempts to avoid cratering and wear of the insert due to abrasion with the workpiece have provided only modest increases in tool life and efficiency. One approaching the prior art has been to form inserts of high strength materials such as tungsten carbide. Although extremely hard, tungsten carbide inserts are brittle and are subject to chipping which results in premature failure. To improve the lubricity of inserts, materials such as hardened or alloyed ceramics have been employed in the fabrication of cutting inserts. Additionally, a variety of low friction coatings have been developed for cutting inserts to reduce the friction between the cutting insert and workpiece.

In addition to the improved materials and coatings used in the manufacture of cutting inserts, attempts have been made to increase tool life by reducing the temperature in the “cutting zone”, which is defined by the cutting edge of the insert, the insert-workpiece interface and the area on the workpiece where material is sheared to form chips. One method of cooling practiced in the prior art is flood cooling which involves the spraying of a low pressure stream of coolant toward the cutting area. Typically, a nozzle disposed several inches above the cutting tool and workpiece directs a low pressure stream of coolant toward the workpiece, tool holder, cutting insert and on top of the chips being produced. The primary problem with flood cooling is that it is ineffective in actually reaching the cutting area. The underside of the chip which makes contact with the exposed top surface of the cutting insert, the cutting edge of the insert and the area where material is sheared from the workpiece, are not cooled by the low pressure stream of coolant directed from above the tool holder and onto the top surface of the chips. This is because the heat in the cutting area is so intense that a heat barrier is produced which vaporizes the coolant well before it can flow near the cutting edge of the insert.

Several attempts have been made in the prior art to improve upon the flood cooling technique described above. For example, the discharge orifice of the nozzle carrying the coolant was placed closer to the insert and workpiece, and/or fabricated as an integral portion of the tool holder, to eject the coolant more directly at the cutting area. Additionally, the stream of coolant was ejected at higher pressures towards the substrate in an effort to break through the heat barrier developed in the cutting area. Other tool holders for various types of cutting operations were also designed to incorporate coolant delivery passageways which direct the coolant flow across the exposed top surface of the insert toward the cutting edge in contact with the workpiece. In these designs, a separate conduit or nozzle for spraying the coolant toward the cutting area was eliminated making the cutting tool more compact. Finally, machine tools of cutting operations have been designed to incorporate cryogenic coolant delivery through machine tool passageways which direct the coolant flow across the exposed top surface of the insert toward the cutting edge in contact with the workpiece or spray cryogenic fluid such as liquid carbon dioxide and liquid nitrogen, and cryogenic mixtures containing water, directly onto the workpiece to cool and remove chips. A common problem with such apparatuses, however, is that coolant in the form of an oil-water or synthetic mixture, at ambient temperature, is directed across the top surface of the insert toward the cutting area without sufficient velocity to pierce the heat barrier surrounding the cutting area. As a result, the coolant fails to reach the boundary layer or interface between the cutting insert and workpiece and/or the area on the workpiece where the chips are being formed before becoming vaporized. Under these circumstances, heat is not dissipated from the cutting area which causes cratering. In addition, this failure to remove heat from the cutting area creates a significant temperature differential between the cutting edge of the insert which remained hot, and the rear portion of the insert which was cooled by coolant, causing thermal failure of the insert.

Another serious problem in present day machining operations involves the breakage and removal of chips from the area of the cutting insert, tool holder and the chucks which mount the workpiece and tool holder. If chips are formed in continuous lengths, they tend to wrap around the tool holder or chucks which almost always leads to tool failure or at least requires a periodic interruption of the machining operation to clear the area of impacted or bundled chips. This is particularly disadvantageous in flexible manufacturing systems in which the entire machining operation is intended to be completely automated. Flexible manufacturing systems are designed to operate without human assistance and it substantially limits their efficiency if a worker must regularly clear impacted or bundled chips.

### BRIEF SUMMARY OF INVENTION

The device of the present invention for applying a cryogenic composition includes a machining tool connected to a delivery line for supplying the machining tool with a dense cryogenic fluid and a diluent or propellant fluid. The machining tool preferably includes a drilling bit having at least one channel axially machined therethrough. A capillary tube is positionable within the channel and has a lesser diameter than the channel. The dense cryogenic fluid, preferably solidified particles of carbon dioxide, is fed into the capillary tube, while the diluent or propellant fluid, preferably in the form of a gas, is fed into the channel. The diluent or propellant fluid flows within the channel and about the capillary tube. Upon exiting the capillary tube, the solidified particles of carbon dioxide admix with the diluent or propellant gas to form the cryogenic composition, preferably within the channel, in the form of a spray. The cryogenic composition, having cooling and optional lubricating properties, exits the channel and is directed onto a substrate being machined.

Another aspect of the present invention is to provide a tool holder having an attachable cutting insert positioned thereon. The tool holder includes the channel machined therethrough, and a similar capillary is positionable within the channel. Dense cryogenic fluid, preferably solidified particles of carbon dioxide, flow within the capillary while the diluent or propellant gas flows within the channel and about the capillary tube. The solidified particles of carbon dioxide admix with the diluent or propellant gas to form the cryogenic composite spray which is directed at an underside of the cutting insert for cooling purposes. Alternatively, a directional nozzle can be attached to the tool holder such that the composite spray can selectively directed onto the cutting insert, the substrate or both.

### BRIEF DESCRIPTION OF THE DRAWINGS

FIG. 1 is a cross sectional view of a machining tool of the present invention.

FIG. 2 is a top view of the machining tool of the present invention as illustrated in FIG. 1.

FIG. 3 is a bottom view of the machining tool of the present invention as illustrated in FIG. 1.

FIG. 4 is a partial cross sectional view of a bit portion of the machining tool of the present invention as illustrated in FIG. 1.

FIG. 5 is a side view of the machining tool of the present invention as illustrated in FIG. 1 machining a substrate.

FIG. 6 is a cross sectional view of an alternative embodiment of the present invention machining substrate.

FIG. 7 is a top view of the alternative embodiment of the present invention.

FIG. 8 is a perspective view of the alternative embodiment of the present invention.

FIG. 9 is a top view of a third embodiment of the present invention.

FIG. 10 is a flow diagram of a system for generating coolant, diluent and propellant gas for use with the present invention.

### DETAILED DESCRIPTION

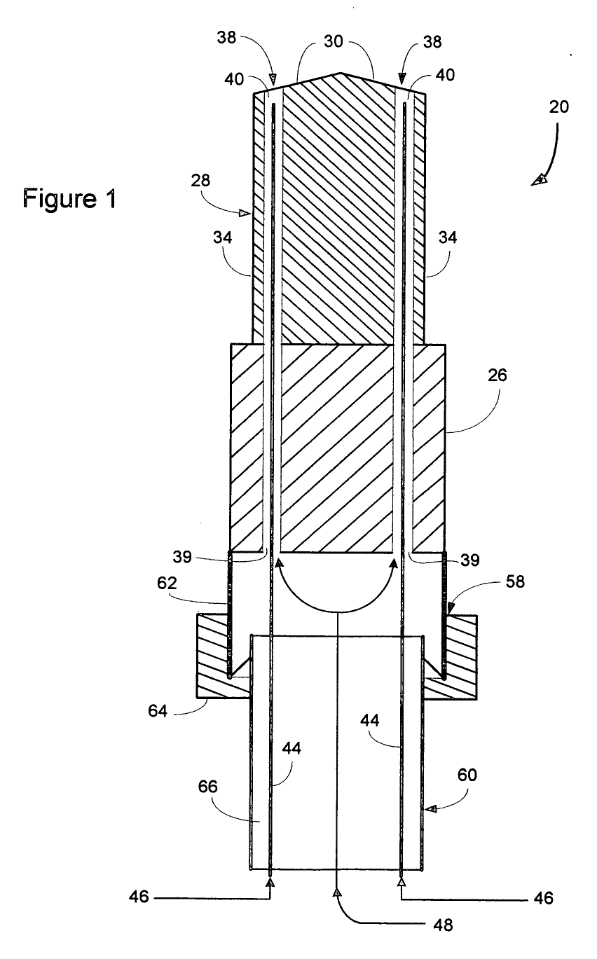

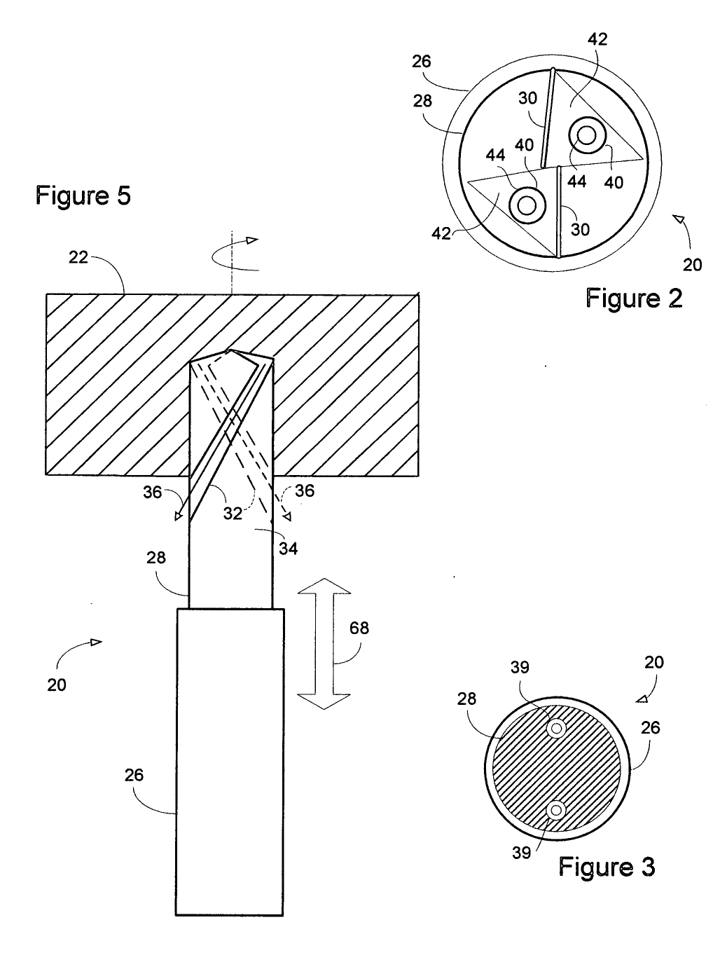

A dual ported spray-through machining tool of the present invention is generally indicated at 20 in FIG. 1. The tool 20 is designed for simultaneously cutting a substrate workpiece 22 while delivering a cryogenic composite machining fluid or spray 24 to the workpiece for cooling or lubricating the workpiece, cooling the tool, or a combination of both. The machining tool 20 of the present invention generally comprises a shank or tool holder portion 26 with a bit portion 28 connected thereto. The shank 26 is preferably engageable with a suitable chuck (not shown) to operably position the machining tool 20 proximate the workpiece 22. The bit portion 28 includes various cutting edges 30 for contacting the workpiece 22. Evacuation channels 32, preferably in a semi-spiral configuration, are positioned on outer surfaces 34 of the bit 28 for directing spent gases and chips 36 formed during the machining process away from the workpiece 22, as illustrated in FIG. 2.

To deliver the composite machining fluid or spray 24 to the workpiece 22, both the shank 26 and the bit 28 include inner channels 38 machined therethrough. Each channel 38 extends the length of the tool 20 beginning with inlet ports 39 positioned within the shank portion 26 and terminating at exit ports 40 positioned within a surface 42 proximate the cutting edges 30. Positionable within each inner channel 38 is a capillary tube 44 for transporting coolant or additive 46. As illustrated in FIGS. 2 and 3, each capillary tube 44 has a lesser diameter than the respective channel 38 in which the capillary 44 is positioned to allow diluent or propellant to flow between a surface 50 of the inner channel 38 and an outer surface 52 of the capillary tube 44. Also, when positioned within the inner channels 38, the capillary tubes 44 are unanchored to the respective inner channel 38 and are free to float within each inner channel 38 when the diluent 48 or propellant flows therein. It should be noted, however, that while this description and the referenced Figures include the first and second inner channels, into which are positioned the respective first and second capillary members, any number of inner channels, including only one, along with the respective capillary member(s), is well within the scope of the present invention.

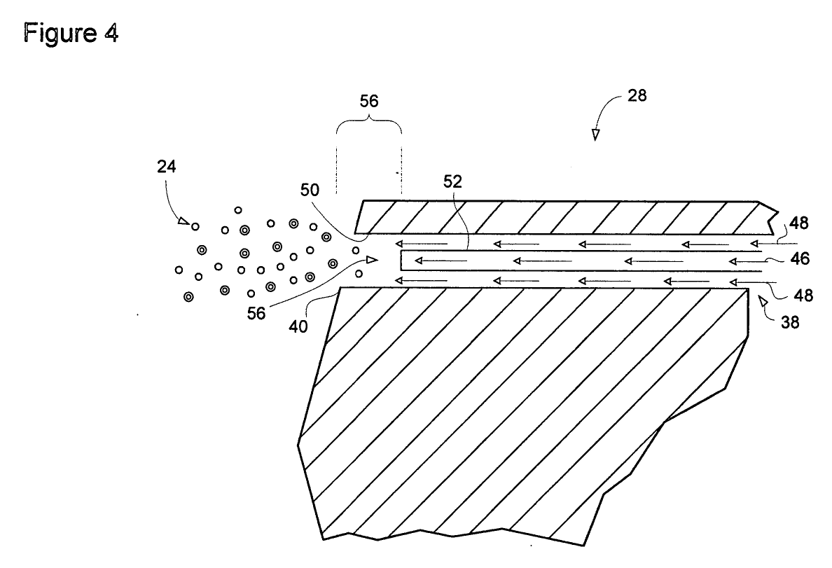

As illustrated in FIG. 4, each capillary tube 44 is selectively positionable within each inner channel 38 to terminate at a selected distance 54 from the respective exit port 40. By selectively positioning the capillary tube 44 relative to the port 40, segregated coolant phase 46 and diluent phase 48 constituents can be mixed within a selected portion 56 of the inner channel 38 prior to the exit port 40 to form the desired composite machining fluid or spray 24. The selected distance 54 is preferably within the range of 1.6 mm (0.0625 inches) to 20 cm (8 inches). Alternatively, the capillary tube 44 can be positioned at the exit port edge 40, resulting in the selected distance 54 being equal to zero, in which case the composite machining fluid or spray 24 is formed at the cutting edge 30 to selectively cool the bit portion 28, especially surfaces proximate the cutting edges.

Affixed to the shank portion 26 is a coaxial adapter assembly 58 for connecting a coaxial delivery line 60 thereto. The coaxial adapter 58 connects to the delivery line 60 preferably via a Swagelok tube fitting 62 secured to the shank 26 and a ferrule seal 64. The delivery line 60 includes an outer feed tube 66, which can be both rigid and flexible, that houses the capillary tubes 44. The outer feed tube 66 delivers the diluent 48 or propellant gas to the adaptor 58 whereupon the diluent 48 or propellant gas enters the inner channels 38 via the inlet ports 39. Each capillary line 44 delivers solid carbon dioxide particles and optional additives to be mixed with the diluent or propellant gas, which the formation of each will be discussed. Upon intermixing with one another, the coolant and diluent or propellant gas form the composite machining fluid or spray 24 exiting via each exit port 40.

The flexible or rigid coaxial delivery assembly 60 preferably has a length within the range of 0.6 m (2 feet) to 9.1 m (30 feet). The diluent tube (8) preferably has a diameter of between 3.2 mm (0.125 inches) and 19 mm (0.75 inches). As discussed, the delivery line 60 affixes to the exemplary cutting tool using the coaxial adaptor 58, wherein the capillary coolant delivery tubes 44 are fed down toward the inlet ports 39 and into the inner channels 38, which now serve as a rigid coaxial feed. The coolant delivery tubes 44 preferably have an outer diameter ranging from 0.8 mm ( 1/32 inch) to 6.4 mm (¼ inch) and an inner diameter ranging from 0.127 mm ( 1/20 inch) to 3.175 mm (⅛ inch). The feed tube 66 and coolant delivery tubes 44 are preferably constructed from Teflon, PEEK, Stainless Steel, polyolefin, nylon or combinations thereof.

In operation, and with reference to FIG. 5, the machining tool 20 of the present invention is employed to drill into the workpiece 22. The workpiece 22 is rotated while the machining tool 20 is plunged or pecked, indicated by arrow 66, into the workpiece 22 at a force and distance as required to produce a desired cut quality and penetration depth. Prior to and during this machining process, diluent, coolant and optional additive components continuously flow through the delivery line 60 and through the tool 20, eventually exiting the exit ports 40 as the composite machining fluid or spray 24. Pressure, temperature and concentration of the machining fluid 24 are controlled independent of mass flow and particle size distribution. Moreover, the coolant phase 46 carried within each capillary tube 44 may be selectively turned on and off to produce alternating machining fluid discharge patterns with the diluent phase, which is never turned off during machining. This is beneficial in certain deep drilling operations to assist with both chip and heat evacuation along the drill channels 32.

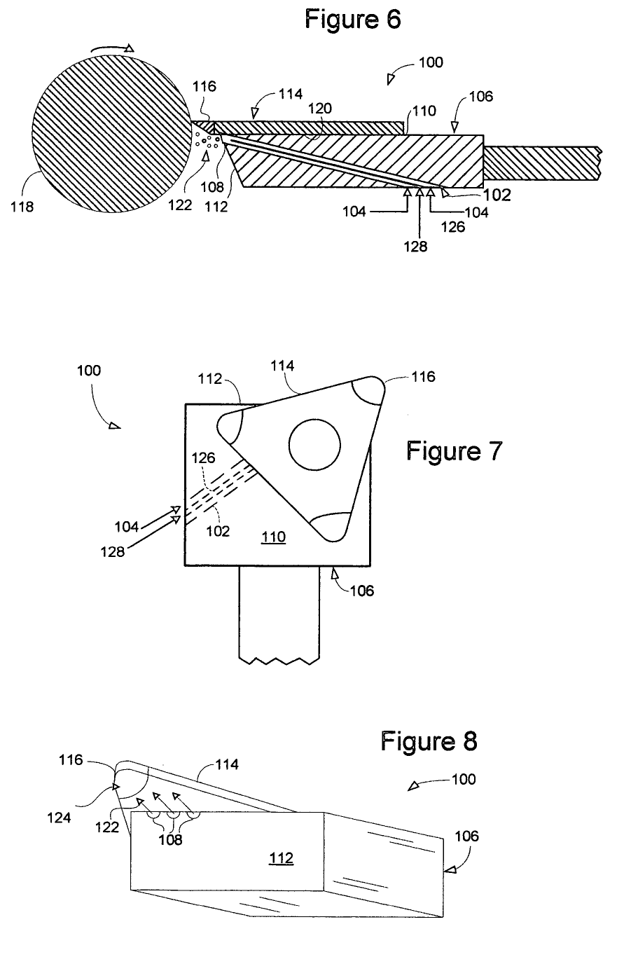

Referring now to FIGS. 6, 7 and 8, a second embodiment of the present invention is generally indicated at 100. The second embodiment includes an inner channel 102 for delivering the diluent 104 or propellant gas, as similarly described with respect to the preferred embodiment 20. The inner channel 102 is bored through a tool-holder 106 and preferably includes several exit ports 108 which terminate at both a top surface 110 and an adjacent side surface 112 of the tool-holder 106. A tool insert 114, having carbide tips 116 for machining a rotatable workpiece 118, is attachable to the tool-holder 106 and positioned directly above the inner channel 102 and exit ports 108 such that a portion of a bottom surface 120 of the insert 114 will be in intimate contact with any composite fluid 122 exiting through each port 108. Additionally, the exit ports 108 are preferably directed to an under-portion 124 of the carbide tip 116 which contacts the workpiece 118 during machining operations. Positioned within the inner channel 102 is a coolant delivery tube 126 for delivering coolant 128 in the same fashion as previously described with respect to the preferred embodiment 20. A delivery line (not shown) is also connectable to the inner channel 102 in the same manner as described with respect to the first embodiment 20 to deliver diluent 104 or propellant gas. The second embodiment 100 preferably directs composite machining fluid or spray 122 at the insert 114 more so than the workpiece 118. This enables temperature control of the cutting insert 114 for extension of insert life.

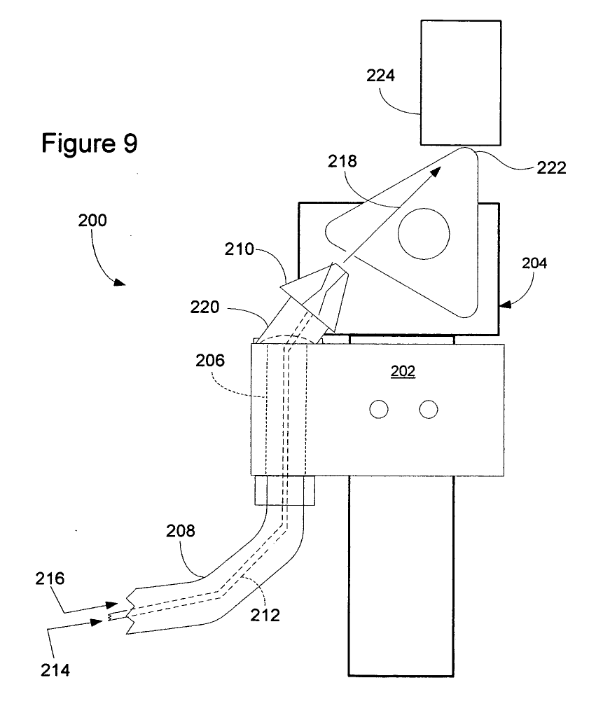

To provide composite machining fluid or spray to a workpiece in a lathe-like setting, a third embodiment is generally indicated at 200 in FIG. 9. The third embodiment includes a mounting block 202 which is affixed to a portion of a toolholder 204. The mounting block 202 include a coaxial channel 206 machined therethrough. The coaxial channel 206 is connected to a coaxial delivery tube 208 similar to that of the previous embodiments 20 and 100. A directable nozzle 210 is attached to the mounting block 202, through which a coolant delivery tube 212 is positioned. Coolant 214 is feed into the coolant delivery tube 212 and diluent 216 or propellant gas is fed into the coaxial channel 206 to produce a composite spray 218 exiting the nozzle 210. Preferably, the nozzle 210 is a co-axial dense fluid spray applicator as taught by the present inventor and fully disclosed in U.S. Pat. No. 5,725,154 which is hereby incorporated herein by reference. More preferably, the spray applicator is a tri-axial type delivering device as taught by the present inventor and fully disclosed in U.S. Provisional Application No. 60/726,466 entitled TRIAXIAL COANDA APPARATUS AND METHOD FOR FORMING AND DELIVERING A COMPOSITE CRYOGENIC SPRAY, which is hereby incorporated herein by reference. The nozzle 210 attaches to the mounting block 202 by way of a swivel 220, and upon exiting the nozzle 210, the composite machining fluid or spray 218 is selectively directed at an insert 222, at a workpiece 224, or both.

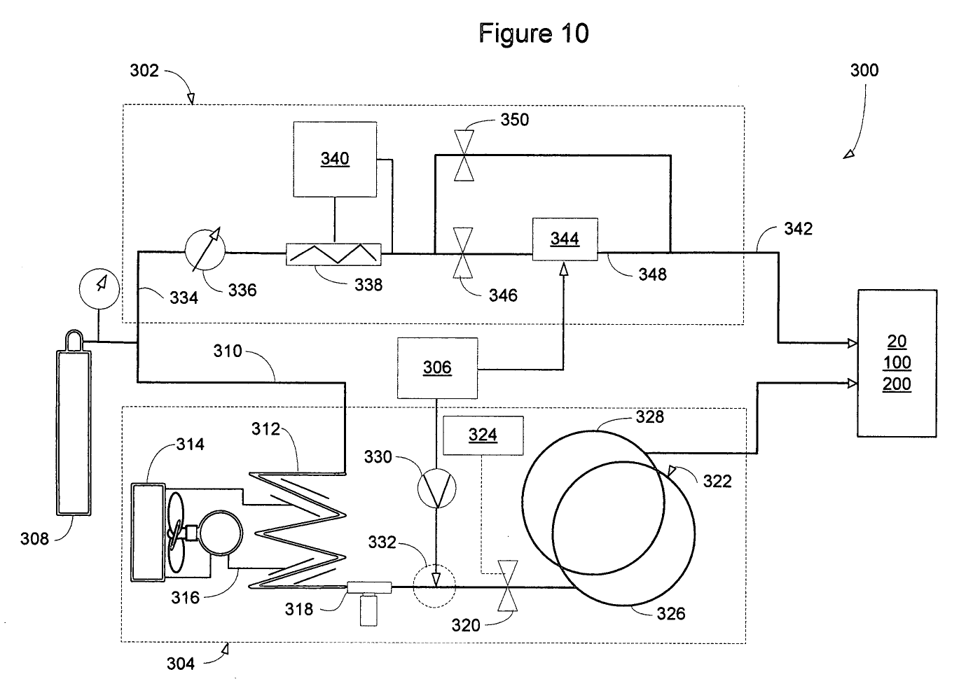

Preferably, the cryogenic machining fluid is that as taught by the present inventor and fully disclosed in U.S. application Ser No. ______ entitled CRYOGENIC FLUID COMPOSITION filed concurrently herewith and which claims the benefit of U.S. Provisional Patent Application No. 60/635,399, which this application also claims the benefit of, both of which are hereby incorporated herein by reference. In brief, a system for generating the coolant, diluent and propellant gas to form the cryogenic composite machining fluid for use in the described embodiments 20, 100 and 200, is generally indicated at 300 in FIG. 10. The cryogenic machining fluid generation and delivery system 300 comprises a diluent phase generation subsystem 302 and a coolant phase generation subsystem 304 connected to the machining tool applicator 20, 100 and 200. Additionally, the diluent generation subsystem 302, coolant generation subsystem 304 and machine tool applicator (500) may be individually integrated with an additive phase supply and delivery subsystem 306. A common supply of high pressure carbon dioxide gas 308, having a preferred pressure range of between 2.1 MPa (300 psi) and 6.2 MPa (900 psi), supplies both the diluent phase generation subsystem 302 and a coolant phase generation subsystem 304.

With respect to the coolant phase generation subsystem 304, carbon dioxide gas contained in the supply cylinder 308 is fed through a connection pipe 310 to a tube-in-tube heat exchanger 312, wherein a compressor-refrigeration unit 314 re-circulates cooled refrigerant 316 countercurrent with the carbon dioxide gas, condensing the carbon dioxide gas into a liquid coolant stock. Liquid carbon dioxide coolant stock flows from the heat exchanger 312 through a micrometering valve 318, through a base stock supply pulse valve 320 and into a capillary condenser unit 322. It should be noted that more than one capillary unit may be employed to provide carbon dioxide snow having variable properties. Optionally, the coolant stock supply valve 320 may be pulsed first opened and then closed at a pulse rate of greater than 1 pulses per second (>1 Hertz) using one or more electronic pulse timers 324. Additionally, coolant stock supply valves may be oscillated on and off to feed coolant stock selectively and alternately into each capillary condenser at different times and rates using the electronic oscillator 324. High frequency pulsation may be preferred to introduce significant velocity gradients (energy waves) within the solid particle stream without discontinuing the generation and flow of solid particles. Oscillation may be preferred to selectively introduce the coolant through any additional spray applicators or to produce alternations within the machine tool applicator 20, 100 and 200. In certain machining operations, alternating the spray within a cutting zone is beneficial for selectively directing a spray composition into a selected portion of the cut to optimize cooling and lubrication as well as assist with chip evacuation.

Preferably, the capillary condenser is a stepped capillary condenser as taught by the present inventor and fully disclosed in U.S. application Ser. No. ______ entitled CARBON DIOXIDE SNOW APPARATUS, filed concurrently with the present application and claiming priority from U.S. Provisional Application No. 60/635,230, both of which are hereby incorporated herein by reference. In brief, the capillary condenser unit 322 is constructed using a first 61 cm (24 inch) segment 326 of PolyEtherEtherKetone (PEEK) tubing, for example 0.76/1.6 mm (0.030/0.0625 inch) inside/outside diameter tubing connected to a second 91 cm (36 inch) segment 328 of larger diameter PEEK tubing, for example 1.5/3.2 mm (0.060/0.125 inch) inside/outside diameter tubing, providing a stepped capillary apparatus for condensing (crystallizing) liquid carbon dioxide into solid carbon dioxide snow particles. A stepped capillary condenser efficiently boils liquid carbon dioxide base stock under a pressure gradient to produce a mass of predominantly solid phase carbon dioxide coolant phase. The output from the capillary condenser unit 322 comprises a PEEK tube 329 which is eventually introduced into the delivery feed line and connected to the applicator 20, 100 and 200.

An additive injection pump 330 may be incorporated for injecting an optional additive phase derived from the additive supply system 306 and injected and mixed directly into the liquid carbon dioxide coolant stock using an in-line static mixer 332 and prior to condensing into a coolant-additive binary composition using the capillary condenser unit 322.

With respect to the diluent phase system 302, the supply of carbon dioxide gas 308 is fed via a connection pipe 334 and into a pressure reducing regulator 336 capable of regulating the carbon dioxide gas pressure between 70 kPa (10 psi) and 1 MPa (150 psi), or more. Regulated carbon dioxide gas is fed into an electrical resistance heater 338 controlled by a temperature controller 340 at a temperature of between 293 K and 473 K, or more. Following this, temperature-controlled carbon dioxide gas is fed into either the diluent phase feed tube 342 or into an aerosol generator 344 by way of aerosol generator inlet valve 346. The aerosol generator 344 is connected to the additive supply system 306, which can mix any variety of additives comprising liquids, gases, solids and mixtures thereof into the temperature-regulated carbon dioxide propellant gas at a rate of between 0 liters per minute and 0.02 liters per minute or more, thus forming a temperature-regulated carbon dioxide diluent phase (aerosol) which is fed via a connection pipe 348 into the diluent phase feed tube 342. Alternatively, temperature-regulated carbon dioxide propellant gas may be fed via an aerosol generator bypass valve 350, by-passing said aerosol generator 344, and connecting directly into the propellant aerosol feed connection pipe 348 and into said diluent phase feed tube 342. It should be noted that the use of pressure-regulated compressed air or nitrogen gas, and other inert gases in place of pressure-regulated carbon dioxide gas to produce a diluent phase supply for a particular machining application is well within the scope of the present invention.

Having formed a coolant phase and a diluent phase, each of which may include the optional additives, both components are integrated and delivered to the exemplary machine tool applicator system 20, 100 and 200 using the coaxial spray delivery line. It should be noted that using capillary and coaxial tubes as described above to selectively transport, mix and spray a composite spray provides an adaptable way for integrating the composite spray with any variety of machine tools and any other machining apparatus under variable but generally much lower operating spray pressures and selectively within each machine tool port. Using PEEK capillaries within the machine tool 20, 100 and 200 insulates the internal sidewalls of machine tool ports from the coolant phase which prevents the tool body of tool from exhibiting a severe thermal gradient.

Although the present invention has been described with reference to preferred embodiments, workers skilled in the art will recognize that changes may be made in form and detail without departing from the spirit and scope of the invention.

1. A method of applying a composite fluid during a machining process comprising:
providing a machining tool positionable proximate a substrate to be machined, the machining tool having a channel bored therethrough;
providing a tube positionable within the channel;
supplying the channel with a first fluid, the first fluid flowable within the channel and about the tube; and
supplying the tube with a second fluid, the second fluid flowable within the tube, whereupon exiting the tube, the second fluid admixes with the first fluid to form the composite fluid which exits the channel.
